(19) United States
(12) Patent Application Publication
(10) Pub. No.: US 2003/0021659 A1
(43) Pub. Date: Jan. 30, 2003

(54) Vibration reduction assembly for a web converting machine component

(76) Inventor: James R. Michler, Ashland, WI (US)

Correspondence Address: MICHAEL BEST & FRIEDRICH, LLP, 100 E WISCONSIN AVENUE, MILWAUKEE, WI, 53202, US

(21) Appl. No.: 09/917,296

(22) Filed: Jul. 27, 2001

(51) Int. Cl. B65H 29/00; B65G 1/00; B65G 65/00

(52) U.S. Cl. 414/315; 271/187

(57) ABSTRACT

In a preferred embodiment, the web product manipulation device of the present invention is a finger having a constrained layer damping assembly coupled thereto. The constrained layer damping assembly preferably has a damping layer located between a constraining layer and an elongated body at least partially defining the finger. The damping layer preferably includes viscoelastic damping material, and the constraining layer is preferably a resilient element such as a strip of metal on the damping layer. The application of the constrained layer damping assembly to the finger dampens vibrations induced in the finger during operation. This reduces deflection in the end of the finger caused by vibration, thereby allowing the machine in which the finger is installed to be operated at higher speeds.

### FIELD OF THE INVENTION

The invention relates to devices and methods for reducing vibration-induced deflection, and more particularly to devices and methods for reducing vibration-induced deflection in web manipulation components of web converting machinery.

### BACKGROUND OF THE INVENTION

Despite numerous developments in web converting machinery, several problems still exist with conventional designs. Moving elongated members in web converting machinery are regularly used in a variety of ways to sort, stack, move, fold, compress, separate, count, pack or otherwise manipulate products such as napkins, tissues, sheets of paper and the like. Typically, such elongated members are in the form of fingers (e.g., packer fingers, count fingers, stacking fingers, and the like), although other types of elongated members are common. To increase production and maximize profits, the handling and processing of these materials during manufacturing at the highest rate possible is extremely desirable.

By their nature, web manipulation fingers generally have a length significantly greater than their width and thickness. This shape is often necessary for the fingers to effectively move between individual pieces of material and between or around other components of machinery while still effectively supporting, separating or otherwise manipulating web product. The fingers are also often (but not necessarily) mounted in a cantilever fashion, having one end coupled to a pivot, frame element, actuator, or carriage of the machine and another unsupported end generally configured to be inserted between individual sheets of product or to otherwise adjust the configuration of the product or stacks of the product in some way, such as to stack, sort, transport, pack, separate, compress and/or fold the product or stacks of the product. Typically, these fingers are made of a lightweight metal such as aluminum, although other rigid or substantially rigid materials such as other metals, plastics, composites, ceramics, and the like can instead be used.

The high speeds at which web manipulation machines are often required to operate often subject the fingers to significant vibration. This vibration, combined with the shape, mounting configuration and generally low vibration-damping properties of traditional web manipulation fingers, can lead to significant vibration-induced oscillatory deflections in the fingers. These deflections are commonly in the ends of the fingers, although significant deflections can occur at other locations of the fingers. As operating speeds increase, in some cases these deflections can become so large that the fingers collide with each other or with other components of the machinery.

During operation, many machine frames, assemblies, and elements often experience vibrations at a variety of frequencies from drive systems, motors, and any number of moving parts or components. Many of these vibrations are proportional to the speed of the machine. When the frequency of one of the machine vibrations happens to match the natural frequency of a web manipulation finger, the finger will vibrate at that natural frequency. If this situation is maintained, the vibration amplitude in the finger can increase due to the well-known phenomenon of harmonic resonance. Especially in this situation, large vibration-induced deflections in the ends of the fingers can be generated and can cause the fingers to collide with each other and with other machine components.

There are several known solutions to the problem of excessive vibration in machine components. However, it is normally not practical to modify an entire web stacking machine in order to reduce machine frame vibrations to a level sufficient to prevent the fingers from developing large vibration-induced deflections. Such an undertaking would require extensive vibration damping efforts throughout the machine componentry including the alteration of drive mechanisms, structural components, and so on. Also, it is normally not possible to reduce vibration-induced deflections by making the fingers thicker in an effort to stiffen them such that their natural frequency is above the range of machine frame vibrations. As previously mentioned, web manipulation finger are often designed to be inserted between and to pass through gaps in both sheets of web product as well as machine components. Therefore, the maximum thickness of the fingers is typically limited by available space between other crucial machine components. In addition, the weight of the fingers is an important design concern, and can significantly affect machine efficiency, maximum speed, and power consumption.

In order to increase the operating speeds of machines using web manipulation fingers beyond what is possible with current technology, an effective manner of damping vibrations in these fingers must be found. In these and other applications, an effective manner of reducing vibration-induced finger deflection can be highly desirable for a number of reasons, including increased machine control, reduced parts wear and breakage, lower machine noise, etc. By damping vibrations in the fingers, the effects of harmonic resonance will be counteracted, preventing the build-up of large deflections at the unsupported ends of the web manipulation fingers. Since each machine often uses a relatively large number of web manipulation fingers, a practical solution must also be a low cost solution that is easy to manufacture and is preferably readily adaptable to current web manipulation machinery. In light of the problems and limitations described above, a need exists for a web manipulation finger design and method that dampens web manipulation finger vibration, controls and preferably reduces vibration-induced finger deflection, prevents web manipulation fingers from colliding with each other and with other machine components (such as when the web manipulation machinery is operated at high speeds), can be applied to existing equipment, and is relatively inexpensive from the standpoint of machine manufacturing, assembling, and maintenance. Each preferred embodiment of the present invention achieves one or more of these results.

### SUMMARY OF THE INVENTION

In one preferred embodiment of the present invention, a web converting machine includes one or more elongated fingers. The elongated fingers are movably coupled to the web converting machine and can be used to stack, sort, separate, transport, pack, compress, fold, or otherwise manipulate products that are typically produced at least partially from a web of material, such as tissues, napkins, paper towels, diapers, sheets of paper, and the like. The fingers can have one end coupled to the associated machine and another unsupported end that is movable to manipulate web product, such as to pass between individual sheets of product or other machine components, to pack a stack of product, and the like. In some embodiments, the fingers have lengths significantly greater than their width or thickness.

It will be appreciated by one having ordinary skill in the art that the finger of the present invention can be employed in a large number of different machines used to manipulate and process a number of different types of material in sheet, strip, film, or other similar form. For example, the material can be paper (e.g., for napkins, paper toweling, toilet paper, tissues, and the like), fabric, plastic or other synthetic sheeting material, various types of metal foil, and the like. Therefore, as used herein and in the appended claims, the term “web” is meant to include paper products, plastics, fabrics, synthetic sheeting materials, metal foils, and any other sheet material that can be folded, interfolded, stacked, or otherwise manipulated in a converting machine.

Although significant advantages result from employing the present invention in web stacking machines, it should be noted that the present invention provides significant benefits in any web converting equipment having packer fingers, sorter fingers, stacking fingers, or any other such elongated bodies that are used to manipulate web product and where high rates of operating speed are generally desirable.

In one highly preferred application presented by way of example only, a separator finger is used in a web stacking machine adapted to arrange individual sheets of product into stacks of a predetermined number of sheets. These types of web machines often use well-known devices called “starwheels” that include a plurality of thin curved radially extending fins. When viewed along the rotational axis of the starwheels, the starwheel fins are circumferentially curved in either a clockwise or counterclockwise direction. Preferably, the starwheels rotate such that the free ends of the starwheel fins point in a direction opposite the direction of rotation. Individual sheets of product are guided into spaces between the starwheel fins by a conveyor belt or other transport device or structure. Typically, the sheets are then held between adjacent starwheel fins as the starwheels rotate until they abut a barrier and slide from between the starwheel fins.

In this above-described application, the separator fingers of the present invention are preferably inserted between adjacent starwheels and between adjacent fins of the starwheels to separate adjacent sheets therein. The fingers then move radially outward until they are outside of the starwheels, and support the sheets as they are removed from the starwheels to begin forming a stack. The separator fingers are preferably lowered as sheets continue to be removed from the starwheels until the stack comprises a desired number of sheets. In some embodiments, a second set of separator fingers can then be inserted into the gap between two adjacent starwheel fins, separating two adjacent sheets of product such that one of the adjacent sheets completes the first stack and the other of the adjacent sheets begins the next stack. The first stack is then transferred to a conveyor belt or other transport device or structure (such as by passing through a series of adjacent conveyor belts, by retracting through an apertured barrier to strip the first stack from the separator fingers, and the like) and returns to a position where it can again be inserted between the starwheel fins to complete the second stack of sheets and to begin yet another stack of sheets. This process preferably continues at a relatively very high rate of speed, forming multiple stacks of sheets.

As previously discussed, it is highly desirable to perform stacking operations at high rates of operating speed. Generally, as the speed of the machine increases, the vibrational content associated with the various operations and movements of the machine components and assemblies also increases. It has been observed in the industry that at high operating speeds, conventional web-manipulation fingers (including separator fingers as in the above-described preferred application) may begin to resonate due to machine vibrations. This resonance can lead to excessive vibration-induced deflections of the fingers, such as at the ends of the fingers.

Another example of undesirable component vibration is the vibration experienced by separator arms that support a stack of product and that laterally move the stack prior to dropping or otherwise transferring the stack. The vibration of these arms often include lateral vibrations, and can detrimentally affect machine operation at any speed (e.g., when the arms must move vertically through gaps, slots, or other apertures in and between machine elements, such vibration even at relatively low speed can cause the arms to deflect and jam while moving in this manner). In yet another example, relatively short fingers can be subject to unacceptable deflection. For example, 6-inch long packer fingers can sometimes be employed to reciprocate in a web stacking machine at a speed of up to 20 times per second. Such high-speed operation can induce relatively large deflection in the packer fingers, requiring a modification of the finger design and/or a reduction of the machine operating speed.

As described above, such deflections can cause the fingers to collide with other machine components such as the starwheels or other web manipulation fingers. The present invention provides damping elements for any type of web-manipulation fingers such that vibration-induced deflections are reduced to levels where collisions between fingers and other machine components does not occur. This damping is accomplished through the application of a constrained layer damping system to individual web manipulation fingers.

Some preferred embodiments of the present invention include a relatively thin damping layer of viscoelastic damping material applied to a surface of the separator finger to be damped, followed by the application of a constraining layer to the exposed surface of the viscoelastic material. The viscoelastic material preferably is or includes a viscoelastic damping polymer, such as 3M™ Viscoelastic Damping Polymer #110, #112 or #130, or 3M™ Ultra-pure Viscoelastic Damping Polymer 242. With regard to the separator finger application in FIG. 1, the inventor has discovered that superior damping results are achieved by employing 3M™ Viscoelastic Damping Polymer #112. Alternatively, the damping layer may take the form of other materials that have damping properties with respect to the materials of the fingers and/or the constraining layer. Typically the damping layer includes such relatively flexible materials as rubber, urethane, soft plastic, and viscoelastic materials, as well as other damping materials such as various fibrous material, granular material, and the like. In some applications where the finger and or constraining layer are particularly stiff, the damping layer may even include a relatively stiff material such as metal, ceramic, composite, and the like. One having ordinary skill in the art will appreciate that the type of damping material employed depends at least partially upon the particular application.

In some embodiments, the constraining layer preferably is or includes a thin metal sheet, strip, or plate, while in other embodiments the constraining layer is any layer of preferably substantially rigid material such as plastic, ceramics, composite material (fiber-reinforced or otherwise), metal matrix composite material, and the like. The various types of constraining layers just described are collectively referred to in the appended claims as a “plate”. In the application illustrated in FIG. 1, the constraining layer is preferably selected for stiffness in the longitudinal direction of the fingers, although stiffness in other directions can be selected according to the application.

The relative thicknesses of the various layers described above are preferably a function of the size, shape, material properties and vibrational characteristics of the element being dampened. In one embodiment, aluminum separator fingers are subjected to vibrations in the cross-machine direction and each have a thickness in this direction of about 0.25 inches, the viscoelastic damping layer is applied to a side surface of the finger and has a thickness of about 0.002 inches, and the constraining layer of steel has a thickness of about 0.018 inches. As a result, the increase in thickness to each separator finger is only about 0.02 inches. In this embodiment, a constrained layer damper is applied to one side of the separator fingers, although such a damper can also be applied to an opposite side of each finger if desired. In another embodiment, aluminum separator arms are subject to cross-machine vibration and each have a thickness in this direction of about 0.38 inches, the viscoelastic damping layer is applied to opposite sides of the arm and has a thickness of about 0.002 inches, and respective constraining layers of steel each have a thickness of about 0.018 inches.

The inventor of the present constrained layer damping system has discovered that ratios of finger thickness to combined damping/constraining layer thicknesses between 2:1 and 100:1 provide suitable damping results. Better results are achieved with ratios between 5:1 and 50:1. The best results have been achieved with ratios near 10:1. The relatively small increase in the overall thicknesses of the fingers is highly desirable due to the limited amount of space between starwheels and other machine components through which the separator fingers pass. As a result of the constrained layer damping system on the separator fingers, the amount of vibration and vibration-induced finger deflection is significantly decreased with only a relatively minor increase in separator finger size.

Although the embodiment described above has a constrained layer damping system applied to only one side of each separator finger, the application is adaptable to a wide variety of configurations. By way of example only, a constrained layer damping system of the present invention can be employed on both sides, the top, the bottom, or completely around a web manipulation finger for vibrational damping. Any portion of a web manipulation finger can be provided with the constrained layer damping system of the present invention. Most preferably, the damping layer is applied to the portion of the finger surface experiencing the largest tensile and/or compressive stresses when the finger is vibrating. In some highly preferred embodiments, the damping layer is applied to a surface of the finger experiencing alternating tension and compression as the finger vibrates.

Applying viscoelastic damping material to the above-described surfaces, followed by a constraining layer, causes shear stresses to develop in the viscoelastic damping material as the finger vibrates. These shear stresses in the viscoelastic damping material facilitate the damping of various types of vibrations in the finger.

Other features and advantages of the invention will become apparent to those skilled in the art upon review of the following detailed description, claims, and drawings.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numerals indicate like parts:

FIG. 1 is a side view of a web-stacking machine having a separator finger according to a preferred embodiment of the present invention;

FIG. 2 is a cross-sectional view of a first preferred embodiment of the separator finger taken along line 2-2 of FIG. 1;

FIG. 3 is a cross-sectional view of a second preferred embodiment of the separator finger taken along line 2-2 of FIG. 1;

FIG. 4 is a cross-sectional view of a third preferred embodiment of the separator finger taken along line 2-2 of FIG. 1;

FIG. 5 is an elevational view of a separator finger showing the deflected shapes of the finger in exaggerated phantom; and

FIG. 6 is an enlarged detail view of a portion of a separator finger as shown in FIG. 5, shown with the bending of the finger exaggerated.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION

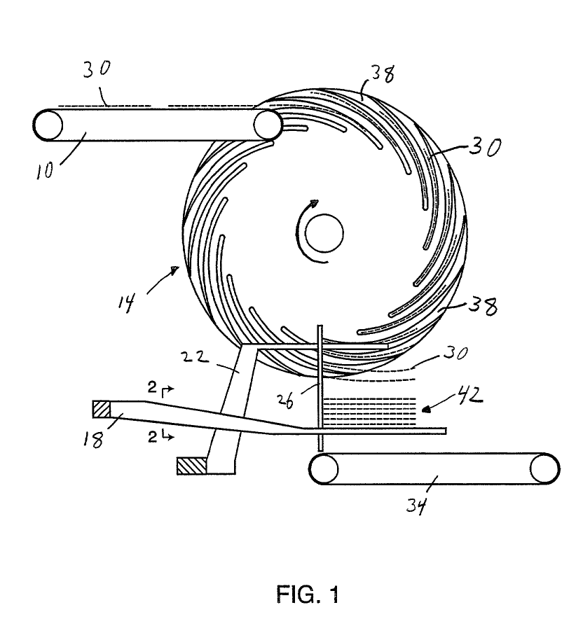

For purposes of describing the present invention, one application in which the present invention can be employed will be described in detail herein. Specifically, and with reference to FIG. 1, a web-stacking machine is illustrated, and has multiple separation fingers (described in greater detail below) that can be subject to undesirable vibration and vibration-induced deflection as described above. As also described above, it should be noted that the present invention can be employed in any other web converting equipment or machine having one or more elongated fingers or like elements subject to undesirable vibration and/or vibration-induced deflection.

The web stacking machine illustrated schematically in FIG. 1 preferably includes an input conveyer 10, a set of starwheels 14, a first set of separator fingers 18, a second set of separator fingers 22, a set of barriers 26, and an output conveyor 34. Sheets of web product 30 travel along the input conveyer 10 until they reach the starwheels 14. The sheets 30 then enter gaps 38 in the starwheel 14 and are transported by rotation of the starwheels 14. Next, the sheets 30 preferably abut the set of barriers 26, slide out of the gaps 38 in the starwheels 14, and are stacked upon the first set of separator fingers 18. As the sheets 30 accumulate in a stack 42 upon the first set of fingers 18, the first set of fingers 18 preferably moves away from the starwheels 14. Preferably, when a desired number of sheets 30 have been added to the stack 42, the second set of separator fingers 22 is inserted between gaps 38 of the starwheel 14 to separate downstream sheets 30 completing the first stack 42 from upstream sheets that begin to form a new stack 42 of sheets 30. If desired, the first set of fingers 18 can unload its stack 42 of sheets 30 onto the output conveyor 34, after which time the first set of fingers 18 returns to a position where it can once again be inserted between a gap 38 of the starwheel 14 to begin forming another stack 42 of sheets 30.

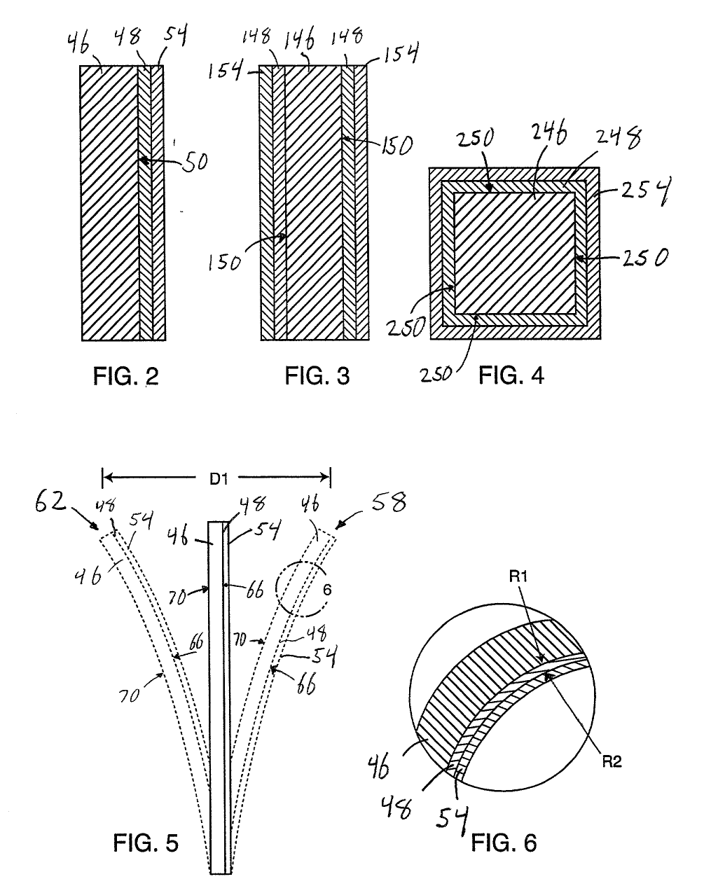

FIGS. 2-4 illustrate preferred embodiments of web manipulation fingers 46 (such as the fingers in the first and second sets of separator fingers 18, 22, or the elements defining the barriers 26 described above) with varying cross-sections, varying constrained layer damping systems, and varying techniques for applying constrained layer damping systems according to the present invention. The web manipulation fingers 46 can be any type of finger commonly found in web manipulation and web converting machinery such as separator fingers, count fingers, fold-over fingers, packer fingers, sorting fingers, stacking fingers and the like. The fingers can be supported or otherwise secured within such machinery in any manner, including without limitation by being cantilevered, partially or fully supported at one or more locations along the length thereof, supported at the ends thereof, and the like.

In each embodiment illustrated in FIGS. 2-4, a damping layer in the form of viscoelastic material 48 is affixed to an outer surface 50 of the web manipulation finger 46. A constraining layer 54 is then applied to the exposed surface of the viscoelastic layer 48 completing the constrained layer damping system assembly. FIG. 2 shows a web manipulation finger 46 having a substantially rectangular cross section with the viscoelastic layer 48 and the constraining layer 54 applied to one surface 50 of the web manipulation finger 46. FIG. 3 shows a web manipulation finger 146 with a similar cross section as FIG. 2 but with viscoelastic layers 148 and constraining layers 154 on opposite surfaces 150 of the finger 146. FIG. 4 shows a web manipulation finger 246 with a substantially square cross-section and a viscoelastic layer 248 and a constraining layer 254 applied to all four surfaces 250 of the finger 246. The viscoelastic layer 248 and the constraining layer 254 can substantially surround the finger 246 as shown, and in some highly preferred embodiments have one or more breaks about the circumference of the finger 246 (not shown).

Although three preferred embodiments of the present invention are disclosed in FIGS. 2-4, it will be appreciated by one of ordinary skill in the art that the cross-sectional shapes of the web manipulation fingers 46, 146, 246 are not limited to being rectangular. The fingers 46, 146, 246 can be any other cross-sectional shape desired, including without limitation round, polygonal (regular or irregular and having any number of sides) and complex shapes. In addition, the web manipulation fingers 46, 146, 246 can have any longitudinal shape desired, such as tapered, straight, stepped, bowed, and curved shapes or complex shapes. The fingers 46, 146, 246 can each be made of a single element or a combination of elements connected together in any conventional manner.

The surfaces 50, 150, 250 covered by the viscoelastic layer 48 can define any side of the web manipulation fingers, such as surfaces which are subject to compression and tension, surfaces which are subject to complex, bending, or shear stresses in and out of the plane of the surfaces, and the like. By way of example only, and as shown in FIG. 4, layers of damping material can be added to a web manipulation finger 46 to reduce vibrations in directions other then in the cross-machine direction and to further improve the performance of web manipulation machinery. However, as described in greater detail below, the viscoelastic layer 48 is most preferably applied to one or more surfaces which are subjected to tension and/or compression due to bending of the web manipulation fingers 46, 146, 246 (i.e., the surface(s) bend in a convex and/or concave manner during operation, and in some applications alternate between these two shapes during operation).

Superior damping performance is achieved when all or substantially all of one or more finger surfaces (e.g., sides) is covered by the viscoelastic layer 48. However, it should be noted that the viscoelastic layer 48 may cover any amount of the finger surfaces. Furthermore, the viscoelastic layer 48 can cover the surfaces entirely, partially, and in any type of pattern, such as in strips, dots, apertured sheets, patches, a grid, web, or mesh, and the like. In short, although the viscoelastic layer 48 is located and takes the form described above in some preferred embodiments, the viscoelastic layer 48 can cover any amount of one or more surfaces of the web manipulation fingers in any non-patterned or patterned manner. Also, the viscoelastic layers 48, 148, 248 are not limited to any particular orientation and configuration, and can be applied to any combination of one or more flat or curved sides or surfaces of any type of web manipulation finger 46, 146, 246.

In some preferred embodiments, the viscoelastic layer 48, 148, 248 is in the form of double sided tape such that it can be quickly and easily applied directly to the surface 50, 150, 250 of the web manipulation finger 46, 146, 246 followed by the direct application of the constraining layer 54, 154, 254 to the exposed adhesive surface of the viscoelastic layer 48, 148, 248. It will be appreciated by one of ordinary skill in the art that any suitable method of affixing the viscoelastic layer 48, 148, 248 between the desired surface 50, 150, 250 of the web manipulation finger 46, 146, 246 and the constraining layer 54, 154, 254 is possible. For example, a brush applied adhesive, cohesive, or other bonding material can be applied to the surface 50, 150, 250 of the finger 46, 146, 246, and/or the viscoelastic layer 48, 148, 248, followed by the application of the viscoelastic layer 48, 148, 248. Another coating of adhesive, cohesive, or other bonding material can then be applied to the exposed surface of the viscoelastic layer 48, 148, 248 and/or the constraining layer 54, 154, 254, followed by the application of the constraining layer 54, 154, 254.

In the description above regarding the application of the constraining layer 54, 154, 254 to the web manipulation finger 46, 146, 246, the viscoelastic layer 48, 148, 248 is described as being first applied to the finger 46, 146, 246, after which time the constraining layer 54, 154, 254 is applied to the viscoelastic layer 48, 148, 248. It should be noted that this sequence of assembly is not required. The viscoelastic layer 48, 148, 248 can instead be applied first to the constraining layer 54, 154, 254 and then to the web manipulation finger 46, 146, 246, or the viscoelastic layer 48, 148, 248 can be applied to both elements after which time the elements are brought together, or the various elements can be assembled in any other order and manner desired. Some inventive aspects of the present invention lie not in the order or manner of construction of the constrained layer damping assembly, but in the arrangement of elements making up the assembly.

The above embodiments employ a viscoelastic layer 54, 154, 254 that is adhered in some manner to the constraining layer 54, 154, 254 and to the web manipulation finger 46, 146, 246. Such a relationship between the viscoelastic layer 54, 154, 254 and the finger 46, 146, 246 and constraining layer 54, 154, 254 is highly desirable for its ability to perform constrained layer damping. However, such damping can be performed when the viscoelastic layer 54, 154, 254 is not adhered to either or both of these elements.

Specifically, the desired constrained layer damping performed by the present invention can be performed by a constrained layer 54, 154, 254 compressed between the constraining layer 54, 154, 254 and the web manipulation finger 46, 146, 246 to be damped. Such compression is possible in a number of different manners. For example, the viscoelastic layer 48, 148, 248 can be retained between these elements by one or more conventional fasteners, including without limitation bolts, screws, clips, rivets, clamps, or posts passed through mating apertures in the constraining layer 54, 154, 254, viscoelastic layer 48, 148, 248, and finger 46, 146, 246. As another example, the contraining layer 54, 154, 254 and/or the web manipulation finger 46, 146, 246 can be provided with conventional fittings for a snap, compression, or interference fit between the constraining layer 54, 154, 254 and the finger 46, 146, 246 to compress the viscoelastic layer 48, 148, 248 therebetween. Such fittings include without limitation buckles, clips, headed or flanged pins, posts, or other extensions one element received within mating apertures or fittings on the other, etc. Still other elements can be used to retain and more preferably compress the viscoelastic layer 48, 148, 248 between the finger 46, 146, 246 and the constraining layer 54, 154, 254, each of which falls within the spirit and scope of the present invention.

In the disclosed embodiment, the web manipulation fingers 46, 146, 246 are preferably made of aluminum and the constraining layer 54, 154, 254 is preferably made of steel, although other materials are possible for both elements. Preferably, both elements are made of relatively stiff material such as metal, composites, fiberglass, plastic, and the like.

The damping characteristics of the constrained layer damping structure according to the present invention is dependent at least in part upon the relative sizes (e.g., thicknesses, lengths, widths, etc.) and shapes of the finger 46, 146, 246, the viscoelastic layer 48, 148, 248, and the constraining layer 54, 154, 254. Consideration must also be given to the material properties of each of these components, operating temperatures thereof, as well as to the nature of the vibrations to which the system will be subjected.

Referring now to FIG. 5, an example of a web manipulation finger 46 having a constrained layer damping system according to the present invention is illustrated. The constrained layer damping system of FIG. 5 is similar to that shown in FIG. 2, and is illustrated with first and second deflected positions 58, 62 shown in phantom. The first and second deflected positions 58, 62 represent the maximum deflections induced in the finger 46 due to vibrations in the cross-machine direction of the web-stacking machine. A deflection distance D1 is indicated on FIG. 5, and represents the magnitude of the deflection at the tip of the web manipulation finger 46 between the first 58 and second 62 deflected positions.

As the finger 46 vibrates toward the first deflected position 58, a first side surface 66 of the finger 46 is put into a state of compression. A second side surface 70 of the finger 46 on an opposite side of the finger 46 is simultaneously put into a state of tension. As the finger 46 moves toward the second deflected position 62, the first side surface 66 is put into a state of tension while the second side surface 70 is put into a state of compression. As the finger 46 vibrates in this embodiment, the first and second side surfaces 66, 70 continue alternating between states of tension and compression. The constrained layer damping system of the embodiment illustrated in FIG. 5 includes the viscoelastic layer 48 and the constraining layer 54 applied to the first side surface 66 of the finger 46. As the finger 46 vibrates, the constraining layer 54 is therefore put into alternating states of tension and compression along with the first side surface 66. This motion, and the manner in which the constraining layer 54 and the surface 66 of the finger move with the intermediate (and flexible) viscoelastic layer 48, generates the desired damping effect upon the finger 46.

Although only one type of constrained layer damping arrangement is illustrated in FIG. 5, it should be noted that the other constrained layer damper locations and arrangements described above can be employed for this and other damping applications. The preceding description regarding constrained layer damper operation applies equally to such other applications. Also, the manner in which the finger or other element moves in such other applications need not necessarily be the same as that shown in FIG. 5. Specifically, relative motion between the surface of the element to be damped and the constraining layer will produce the desired reaction by the damping layer to dampen element vibrations. Such relative motion can be generated by placing the surface in tension, compression, torsion, or any combination of these forces. Therefore, the benefits of the present invention extend to web manipulation fingers and like elements moving and deflecting in a number of different manners.

Referring now also to FIG. 6, which shows the bending of FIG. 5 due to vibration greatly exaggerated for clarity, the interface of the finger 46 and the viscoelastic layer 48 defines a first radius of bending R1, and the interface of the viscoelastic layer 48 and the constraining layer 54 defines a second radius of bending R2 smaller then the first radius of bending R1. Because the viscoelastic layer 48 is firmly and continuously adhered and/or compressed between the finger 46 and the constraining layer 54, the viscoelastic layer 48 experiences shear stresses when the finger 46 is in either deflected position due to the difference in the two radii of bending R1, R2. It should be noted that the constrained layer damping system also effectively damps vibrations if the finger 46 experiences torsional or other forms of vibrations as opposed to oscillatory vibrations as described above. The development of shear strain in the viscoelastic layer 48 gives rise to the damping characteristics of the constrained layer damping system.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

It should be noted that throughout the specification and claims herein, when one element is said to be “coupled” to another, this does not necessarily mean that one element is fastened, secured, or otherwise attached directly to another element. Instead, the term “coupled” means that one element is either connected directly or indirectly to another element or is in mechanical communication with another element. Examples include directly securing one element to another (e.g., via welding, bolting, gluing, frictionally engaging, mating, etc.), elements which can act upon one another (e.g., via camming, pushing, or other interaction), one element imparting motion directly or through one or more other elements to another element, and one element connected to another element via one or more elements. By way of example only, a separator finger can be “coupled” to the frame of a web converting machine by being connected to one or more linear bearing assemblies supported upon a carriage which itself is connected to carriage bearings supported by the machine frame.

What is claimed is:

1. A web converting machine, the web converting machine comprising:
a frame;
at least one elongated finger coupled to the frame, the elongated finger having a surface; and
a constrained layer damper coupled to the surface of the elongated finger to dampen vibrations in the elongated finger.

2. The web converting machine as claimed in claim 1, wherein the constrained layer damper includes a constraining layer and a damping layer, the damping layer positioned between the constraining layer and the surface of the elongated finger.

3. The web converting machine as claimed in claim 2, wherein the damping layer comprises a viscoelastic damping polymer.

4. The web converting machine as claimed in claim 2, wherein the damping layer substantially entirely covers the surface of the elongated finger.

5. The web converting machine as claimed in claim 2, wherein the constraining layer comprises a plate.

6. The web converting machine as claimed in claim 2, wherein the constraining layer covers at a majority of the side of the elongated finger.

7. The web converting machine as claimed in claim 2, wherein:
the damping layer has first and second surfaces coupled to the constraining layer and to the surface of the elongated finger, respectively; and
the damping layer is coupled to at least one of the constraining layer and the surface of the elongated finger with bonding material.

8. The web converting machine as claimed in claim 7, wherein the damping layer is in the form of tape and wherein the bonding material is at least one of adhesive and cohesive.

9. The web converting machine as claimed in claim 2, wherein:
the surface of the elongated finger is at least partially located in a plane;
the elongated finger is subject to vibration in which the surface of the elongated finger vibrates into and out of the plane.

10. The web converting machine as claimed in claim 9, wherein the surface of the elongated finger and the constraining layer oscillate between a state of tension and a state of compression responsive to vibration of the elongated finger into and out of the plane.

11. The web converting machine as claimed in claim 9, wherein the damping layer is subject to shear strain responsive to vibration of the elongated finger into and out of the plane.

12. The web converting machine as claimed in claim 1, wherein the elongated finger has a substantially rectangular cross section and an end defining a tip of the elongated finger.

13. The web converting machine as claimed in claim 1, wherein the constrained layer damper is thinner than the elongated finger.

14. The web converting machine as claimed in claim 13, wherein the elongated finger is no less than five times as thick as than the constrained layer damper.

15. The web converting machine as claimed in claim 1, wherein the elongated finger is one of a plurality of substantially parallel and spaced-apart elongated fingers, each finger having a constrained layer damper coupled to a surface thereof.

16. The web converting machine as claimed in claim 1, wherein the surface is a first surface, the web converting machine further comprising a second constrained layer damper on a second surface of the elongated finger opposite the first surface.

17. The web converting machine as claimed in claim 1, wherein:
the elongated finger is mounted for reciprocal movement in first and second directions; and
the surface substantially faces at least one of the first and second directions.

18. The web converting machine as claimed in claim 1, wherein:
the elongated finger is mounted for reciprocal movement in first and second directions; and
the surface faces substantially laterally with respect to the first and second directions.

19. A web converting machine, the web converting machine comprising:
a frame;
at least one finger coupled to the frame, the finger having:
a surface;
a resilient vibration damping material on the surface; and
a substantially rigid element coupled to the resilient vibration damping material, the resilient vibration damping material sandwiched between the substantially rigid element and the surface of the finger, the substantially rigid element and the resilient vibration damping material at least partially defining a constrained layer damper;
the constrained layer damper positioned on the surface of the at least one finger to dampen vibrations generated by movement and deformation of the at least one finger.

20. A web product manipulation finger, comprising:
an elongated body having an end defining a tip of the finger, the elongated body adapted to manipulate web material; and
a damping assembly coupled to the elongated body, the damping assembly including a layer of damping material located between the elongated body and a constraining layer to dampen vibrations of the elongated body in use.

21. The web product manipulation finger as claimed in claim 20, wherein the layer of damping material comprises a viscoelastic damping polymer.

22. The web product manipulation finger as claimed in claim 20, wherein the layer of damping material substantially entirely covers at least a majority of a side of the elongated body.

23. The web product manipulation finger as claimed in claim 20, wherein the constraining layer comprises a plate.

24. The web product manipulation finger as claimed in claim 20, wherein the constraining layer is coextensive with at least a majority of a side of the elongated body.

25. The web product manipulation finger as claimed in claim 20, wherein the layer of damping material is coupled to at least one of the elongated body and the constraining layer.

26. The web product manipulation finger as claimed in claim 20, wherein the damping assembly is coupled to a surface of the elongated body that is substantially orthogonal to a direction of deformation of the elongated body in use.

27. The web product manipulation finger as claimed in claim 26, wherein the surface of the elongated body and the constraining layer are resiliently deformable between a state of tension and a state of compression in vibration of the elongated finger.

28. The web product manipulation finger as claimed in claim 26, wherein the damping layer is subject to shear stresses during deformation of the elongated body caused by vibration thereof.

29. The web product manipulation finger as claimed in claim 20, wherein the elongated body has a substantially rectangular cross section and an end defining a tip of the elongated finger.

30. The web product manipulation finger as claimed in claim 20, wherein the elongated body is thicker than the damping assembly.

31. The web product manipulation finger as claimed in claim 30, wherein the elongated body is no less than five times thicker than the damping assembly.

32. The web product manipulation finger as claimed in claim 20, wherein:
the elongated body is adapted for movement in a first direction generating deformation of the elongated body; and
the damping assembly is coupled to a surface of the elongated body that substantially faces the first direction.

33. The web product manipulation finger as claimed in claim 20, wherein:
the elongated body is adapted for movement in a first direction generating deformation of the elongated body; and
the damping assembly is coupled to a surface of the elongated body that substantially faces the first direction.

34. A method of manufacturing a web product manipulation finger, comprising:
applying a constrained layer damper to a surface of an elongated body at least partially defining the web product manipulation finger, the constrained layer damper having a damping layer and a constraining layer; and
positioning the damping layer between the constraining layer and the surface of the elongated body.

35. The method as claimed in claim 34, further comprising coupling the damping layer to the finger with adhesive.

36. The method as claimed in claim 34, further comprising coupling the constraining layer to the damping layer with adhesive.

37. The method as claimed in claim 34, wherein the surface is subject to tension and compression resulting from vibration of the web product manipulation finger during operation.

38. The method as claimed in claim 37, wherein the surface is subject to alternative tensile and compressive stresses resulting from vibration of the web product manipulation finger during operation.

39. The method as claimed in claim 34, wherein vibration of the product manipulation finger induces shear stresses in the damping material.
